(19) United States
(12) Patent Application Publication
(10) Pub. No.: US 2024/0413620 A1
(43) Pub. Date: Dec. 12, 2024

(54) WIRE STRIPPING MACHINE

(71) Applicant: Shanghai Oceania International Co.,Ltd., Shanghai (CN)

(72) Inventor: Alexander Yebo CHEN, Lake Forest, CA (US)

(21) Appl. No.: 18/660,795

(22) Filed: May 10, 2024

(30) Foreign Application Priority Data
Jun. 9, 2023 (CN) 202321468486.2

(51) Int. Cl. H02G 1/12

(52) U.S. Cl. CPC H02G 1/1248

(57) ABSTRACT

The present disclosure relates to the technical field of wire processing and discloses a wire stripping machine, which includes a wire entry component, a wire feeding component and a wire stripping component. The wire entry component includes a first wire clamping part and a second wire clamping part with an adjustable spacing, so as to form an adjustable-sized wire entry space between the first wire clamping part and the second wire clamping part. The wire to be stripped can be inserted through the wire entry space. The wire feeding component can transport the wires inserted through the wire entry space in a preset direction; the wire stripping assembly includes a wire stripping knife, which can be lifted and lowered above the wire feeding component. The wire stripping knife can cut into the outer sheath of the wire being fed on the wire feed component. Since the size of the wire entry space is adjustable, wires of different diameters can be stripped, which effectively improves the versatility of this wire stripping machine. Moreover, wires of different diameters are all inserted through the same wire entry space, so there is no need to equip different wire entrances for wires of different diameters. The threading operation is simpler and is conducive to the miniaturization design of the wire stripping machine.

### TECHNICAL FIELD

The present disclosure relates to the technical field of wire processing, in particular to a wire stripping machine.

### BACKGROUND

In the wire production process, waste wires are often generated. In order to recycle and reuse the waste wires, the waste wires are usually stripped to facilitate the classification and recycling of the wire shell and wire core.

In the prior art, the traditional method of stripping wires is manual stripping. However, manual stripping has low efficiency and high cost, and errors may occur due to wire twisting during the stripping process, which resulting in poor stripping results or injuries to operators. In order to solve the above problems, Patent CN216121584U discloses a wire stripping device, which can realize automatic stripping of wires. Such device can prevent the wires from twisting during the stripping process by setting a wire feed duct tube to limit the wire, so that to insure the effect of stripping. However, the above-mentioned stripping device can only strip wires that have a certain diameter, and has poor versatility.

Therefore, there is an urgent need for a wire stripping machine to solve the above problems.

### SUMMARY

Based on the above problems, the purpose of this disclosure is to provide a wire stripping machine that can strip wires of different diameters. The stripping machine has good versatility, has a simple structure and is small in size.

In order to achieve the above purpose, the present disclosure adopts the following technical solutions:

A wire stripping machine is provided, wherein the wire stripping machine includes:
a cable entry component includes a first wire clamping part and a second wire clamping part, the space between the first wire clamping part and the second wire clamping part is adjustable, so that an adjustable-size wire entry space is formed between the first wire clamping part and the second wire clamping part, and the wire to be stripped can be inserted through the wire entry space;
a wire feeding component, the wire feeding component can transport wires inserted through the wire entry space in a preset direction;
a wire stripping component includes a wire stripping knife, the wire stripping knife is disposed above the wire feeding component in a liftable manner, the wire stripping knife can cut into the outer sheath of the wire transported on the wire feeding component.

As a preferred embodiment of the wire stripping machine of the present disclosure, wherein a first wire clamping groove is provided on the first wire clamping part, and a second wire clamping groove is provided on the second wire clamping part, and the first wire clamping groove and the second wire clamping groove forms the wire entry space.

As a preferred embodiment of the wire stripping machine of the present disclosure, wherein the wire stripping machine further includes a rack, and the second wire clamping part is disposed in the rack with an adjustable installation position along the wire clamping direction, the size of the wire entry space can be adjusted by adjusting the installation position of the second wire clamping part.

As a preferred embodiment of the wire stripping machine of the present disclosure, wherein the rack includes a base, a first support plate and a second support plate, the first support plate and the second support plate are placed on the base, the first wire clamping part is provided on the base and is located between the first support plate and the second support plate, two opposite sides of the second clamping part are slidingly connected to the first support plate and the second support plate respectively.

As a preferred embodiment of the wire stripping machine of the present disclosure, wherein a first chute is provided on both the first support plate and the second support plate, two first sliding parts are protruding from opposite sides of the second wire clamping part, and each first sliding part is clamped in the corresponding first chute and are slidingly connected with the first chute.

As a preferred embodiment of the wire stripping machine of the present disclosure, wherein the wire entry component also includes a connected locking block and an adjusting rod, and the first support plate is provided with a guide hole extending along the wire clamping direction, the adjusting rod passes through the guiding hole and is movable along the wire clamping direction, the adjusting rod is threadedly connected to the second wire clamping part, the second wire clamping part can be locked and limited to the first support plate by twisting the adjusting rod using the locking block.

As a preferred embodiment of the wire stripping machine of the present disclosure, wherein the wire feeding component includes a driving member, a driving shaft and a wire feeding wheel, and the wire feeding wheel is coaxially arranged on the driving shaft, one end of the driving shaft is rotationally connected to the first support plate, and the other end is rotationally connected to the second support plate, the output end of the driving member is connected to the driving shaft and is used to drive the wire feeding wheel to rotate to transport the wire in a preset direction.

As a preferred embodiment of the wire stripping machine of the present disclosure, wherein the wire stripping component further includes a tool holder connected with a lifting rod, and the rack further includes a top plate provided at the top of the first support plate and the second support plate, and the lifting rod passes through the top plate and can be raised or lowered, the wire stripping knife is installed on the knife holder.

As a preferred embodiment of the wire stripping machine of the present disclosure, wherein the lifting rod is threadedly connected to the top plate and is rotationally connected to the tool holder, the wire stripping component further includes an elastic member sleeved on the lifting rod, the elastic member is compressed and limited between the tool holder and the top plate.

As a preferred embodiment of the wire stripping machine of the present disclosure, wherein the first support plate and the second support plate are each provided with a second chute, second sliding parts are protruding from opposite sides of the tool holder. The second sliding parts are snaped in the corresponding second slide grooves and can slide along the second chute.

The beneficial effects of this disclosure are:

The wire stripping machine provided by the present disclosure adjusts the spacing between the first wire clamping part and the second wire clamping part according to the wire diameter of the wire to be stripped before stripping, so that the wire entry space can accommodate the wire of the current diameter to penetrate. Then, start the wire feeding component to transport the wire to be stripped in the preset direction. At the same time, lower the wire stripping knife to the preset height so that the wire stripping knife can just cut into the outer sheath of the wire on the wire feeding component. The wire feeding component continuously feeds the wire, and the wire stripping knife cuts the outer sheath of the wire along the wire conveying direction to complete the cable stripping. Since the wire entry space of this wire stripping machine is adjustable, it can strip wires of different diameters, which effectively improves the versatility of this wire stripping machine. Moreover, wires of different diameters are all inserted through the same wire entry space, so there is no need to equip different wire entrances for wires of different diameters. The threading operation is simpler and is conducive to the miniaturization design of the wire stripping machine. In addition, the cooperation between the first wire clamping part and the second wire clamping part can straighten and limit the inserted wire, prevent the wire from moving during the stripping process, and ensure the stripping effect.

### BRIEF DESCRIPTION OF THE DRAWINGS

In order to explain the technical solutions in the embodiments of the present utility model more clearly, the following will briefly introduce the drawings used in the description of the embodiments of the present utility model. Obviously, the drawings in the following description are only illustrations of the present utility model. Those of ordinary skill in the art can also obtain other drawings based on the content of the embodiments of the present disclosure and drawings without exerting creative efforts.

FIG. 1 is a first structural schematic diagram of a wire stripping machine provided by a specific embodiment of the present disclosure;

FIG. 2 is a second structural schematic diagram of the wire stripping machine provided by a specific embodiment of the present disclosure;

FIG. 3 is a first exploded schematic view of the wire stripping machine provided by a specific embodiment of the present disclosure;

FIG. 4 is a second exploded schematic view of the wire stripping machine provided by a specific embodiment of the present disclosure.

In the drawings:
1—Wire entry component; 2—Wire feeding component; 3—Wire stripping component; 4—Rack; 5—Wire entry space; 6—Wire blocking column;
11—First wire clamping part; 12—Second wire clamping part; 13—Locking block; 14—Adjusting rod;
111—First wire clamping groove; 121—Second wire clamping groove; 122—First sliding part;
21—Driving shaft; 22—Wire feeding wheel; 23—First bearing; 24—Second bearing;
31—Wire stripping knife; 32—Tool holder; 33—Lifting rod; 34—Elastic member;
321—Second sliding part; 331—Screwing portion;
41—Base; 42—First support plate; 43—Second support plate; 44—Top plate;
421—First chute; 422—Second chute; 423—Guiding hole; 424—Installation groove.

### DETAILED DESCRIPTION

In order to make the technical problems solved, the technical solutions adopted and the technical effects achieved by the present disclosure clearer, the technical solutions of the embodiments of the present disclosure will be further described in detail below in conjunction with the accompanying drawings. Obviously, the described embodiments are only some embodiments of the technical solutions of the present disclosure, not all embodiments. Based on the embodiments in this disclosure, all other embodiments obtained by those skilled in the art without making creative efforts fall within the scope of protection of this disclosure.

In the description of the present disclosure, it should be noted that the terms “center”, “upper”, “lower”, “left”, “right”, “vertical”, “horizontal”, “inner”, “outer”, etc. The indicated orientation or positional relationship is based on the orientation or positional relationship shown in the drawings, and is only for the convenience of describing the present disclosure and simplifying the description, and does not indicate or imply that the indicated device or element must have a specific orientation or be constructed and operated in a specific orientation, and therefore should not be construed as limitations on the present disclosure. Furthermore, the terms “first” and “second” are used for descriptive purposes only and are not to be construed as indicating or implying relative importance. Among them, the terms “first position” and “second position” are two different positions.

In the description of the present disclosure, it should be noted that, unless otherwise clearly stated and limited, the terms “installation”, “link” and “connection” should be understood in a broad sense. For example, it can be a fixed connection or a detachable connection. It can be a mechanical connection or an electrical connection. It can be a direct connection or an indirect connection through an intermediate medium. It can be an internal connection between two components. For those of ordinary skill in the art, the specific meanings of the above terms in this disclosure can be understood on a case-by-case basis.

In the prior art, such as patent CN107379329B discloses a wire stripping machine. Although it can strip wires of different diameters, it needs to be equipped with wire feeding tubes of different diameters to let wires with different diameters penetrate. And each wire feeding tube needs to be equipped with a blade for stripping wires, which results in the entire wire stripping machine being large in size and taking up a lot of space.

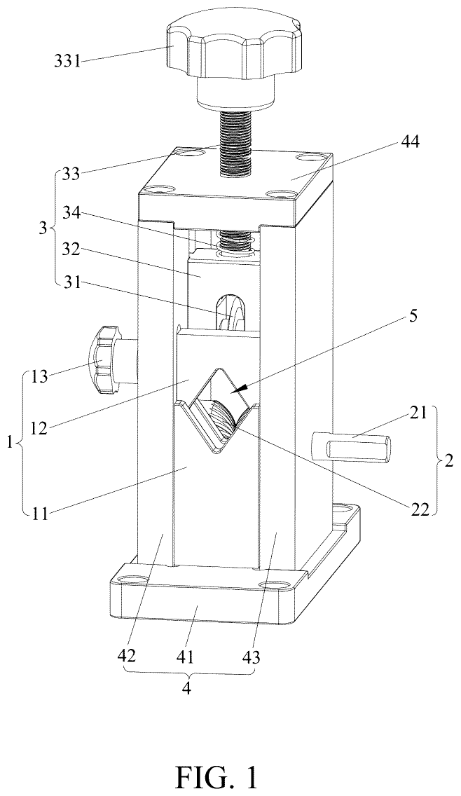

As shown in FIGS. 1 to 4, current embodiment provides a wire stripping machine that can strip wires with different diameters. It has good versatility, a simple structure and is small in size. The wire stripping machine includes a wire entry component 1, a wire feeding component 2 and a wire stripping component 3.

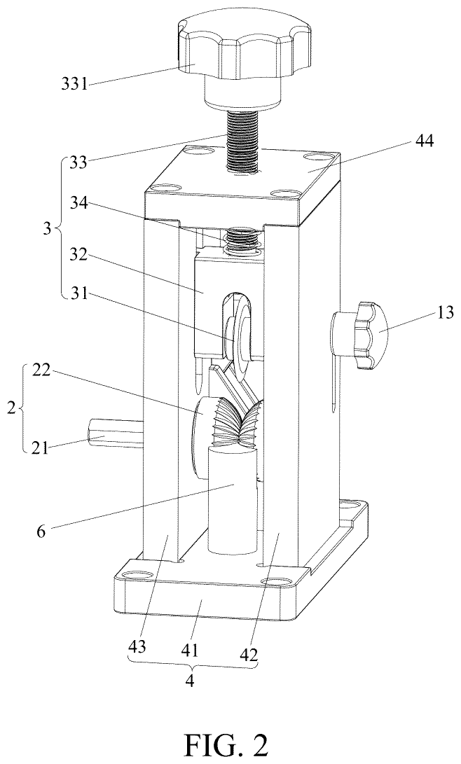

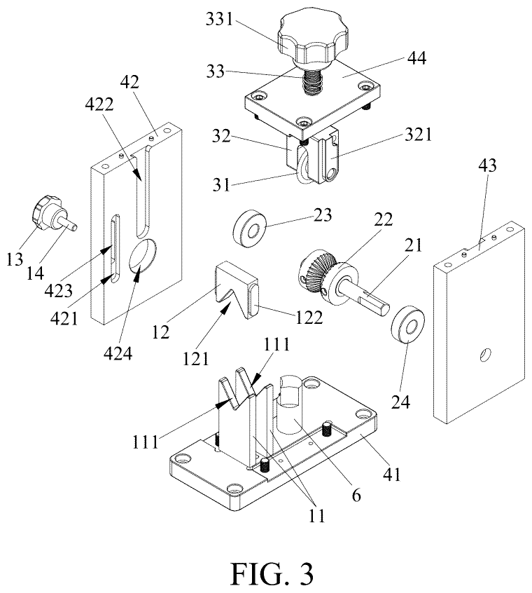

Referring to FIGS. 1 and 3, the wire entry component 1 includes a first wire clamping part 11 and a second wire clamping part 12, the space between the first wire clamping part 11 and the second wire clamping part 12 is adjustable, so as to form a wire entry space 5 with adjustable size between the first wire clamping part 11 and the second wire clamping part 12. The wire to be stripped can be inserted through the wire entry space 5. Referring to FIG. 2, the wire feeding component 2 can transport wires inserted through the wire entry space 5 in a preset direction. The wire stripping component 3 includes a wire stripping knife 31. The wire stripping knife 31 is disposed above the wire feeding component 2 in a liftable manner. The wire stripping knife 31 can cut into the outer sheath of the wire transported on the wire feeding component 2.

Specifically, before stripping, the distance between the first wire clamping part 11 and the second wire clamping part 12 is adjusted according to the diameter of the wire to be stripped, so that the wire entry space 5 can allow the wire with current diameter to penetrate. Then, start the wire feeding component 2 to transport the wire to be stripped along the preset direction. Meanwhile, lower the wire stripping knife 31 to the preset height so that the wire stripping knife 31 can just cut into the outer sheath of the wire on the wire feeding component 2. As the wire feeding component 2 continues to convey the wire, the wire stripping knife 31 cuts the outer sheath of the wire along the wire conveying direction, thereby completing the wire stripping. Since the wire entry space 5 of the wire stripping machine is adjustable in size, wires of different diameters can be stripped, which effectively improves the versatility of the wire stripping machine. Moreover, wires of different diameters are all inserted from the same wire entry space 5, so there is no need to equip different wire entrances for wires of different diameters. The operation of inserting the wire is simpler and it is conducive to the miniaturization design of the wire stripping machine. In addition, the cooperation between the first wire clamping part 11 and the second wire clamping part 12 can straighten and limit the inserted wire, prevent the wire from moving during the stripping process, and ensure the quality of stripping. The above-mentioned preset direction is the axis direction of the wire.

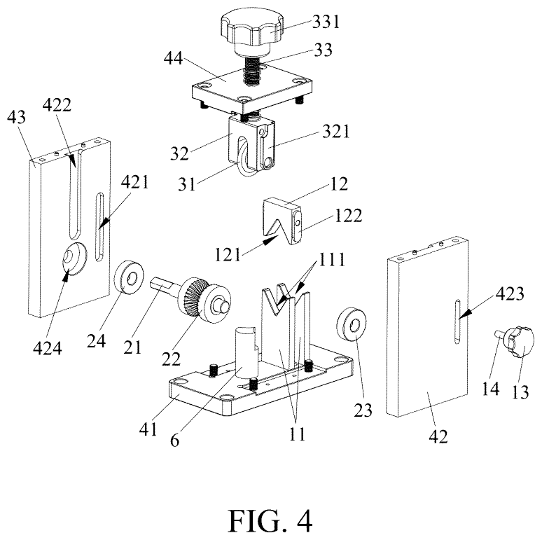

Optionally, referring to FIGS. 3 and 4, the first wire clamping part 11 is provided with a first wire clamping groove 111, the second wire clamping part 12 is provided with a second wire clamping groove 121. The first wire clamping groove 111 and the second wire clamping groove 121 forms the wire entry space 5. In this embodiment, the notch of the first wire clamping groove 111 faces upward, and the notch of the second wire clamping slot 121 faces downward, so that when the distance between the first wire clamping part 11 and the second wire clamping part 12 changes, the size of the wire entry space 5 is changed to adapt to the penetration of wires with different diameters. The arrangement of the first clamping groove 111 and the second clamping groove 121 can limit and fix the wire to prevent the wire from being displaced randomly during the stripping process, thus ensuring that the cutting depth of the stripping knife 31 is consistent and will not cause scratches of the wire core, and ensuring the quality of stripping.

Referring specifically to FIG. 3 of this embodiment, both the first wire clamping groove 111 and the second wire clamping groove 121 are V-shaped grooves. The V-shaped grooves are designed to accommodate wires of different diameters. At the same time, the two side walls of the V-shaped groove can also provide sufficient support points for the wire to ensure that the first wire clamping part 11 and the second wire clamping part 12 are able to clamp the wire.

It can be understood that the first wire clamping part 11 and the second wire clamping part 12 do not completely fix the wire, and the extent of clamping the wire allows the wire to move in the preset direction under the movement of the wire feeding component 2.

Further, referring to FIGS. 1, 3 and 4, there are two first wire clamping parts 11, two first wire clamping parts 11 are placed at intervals. The second wire clamping part 12 is located in the middle of the two first wire clamping part 11. The two first wire clamping parts 11 support the wire to be stripped. After the second wire clamping part 12 cooperates with the first wire clamping part 11 to clamp the wire, it can limit and fix the wire so that the wire is always transported in the preset direction. At the same time, during the wire transportation process, the second wire clamping part 12 can always exert pressure on the wire to straighten the wire and prevent the wire from twisting.

Optionally, referring to FIGS. 1 and 2, the wire stripping machine also includes a rack 4. The second wire clamping part 12 is disposed in the rack 4 with an adjustable installation position along the wire clamping direction. By adjusting the installation position of the second wire clamping part 12, the size of the wire entry space 5 can be adjusted. In this embodiment, the first wire clamping part 11 is fixed, and the second wire clamping part 12 is disposed above the first wire clamping part 11 in a liftable manner. Before inserting the wire to be stripped, lift up the second wire clamping part 12. After inserting the wire, lower the second wire clamping part 12 to clamp the wire together with the first wire clamping part 11, so that the wire of a certain diameter can be stripped. The size of the wire entry space 5 is adjusted by lifting and lowering the second wire clamping part 12, which is easy to adjust. It meets the needs of stripping wires with different diameters, and improves the versatility of the wire stripping machine.

Optionally, referring to FIGS. 1 and 2, the rack 4 includes a base 41, a first support plate 42 and a second support plate 43. The first support plate 42 and the second support plate 43 are placed on the base 41. The first wire clamping part 11 is provided on the base 41, and is located between the first support plate 42 and the second support plate 43. Two opposite sides of the second clamping part 12 are slidingly connected to the first support plate 42 and the second support plate 43 respectively. That is, the first wire clamping part 11 is fixed on the base 41 and the second wire clamping part 12 can slide relative to the first support plate 42. By driving the second wire clamping part 12 to slide, the position of the second wire clamping part 12 can be adjusted. The adjustment of the position is convenient.

Specifically, referring to FIG. 3 and FIG. 4, the first support plate 42 and the second support plate 43 are both provided with a first chute 421. Two first sliding part 122 are protruding from opposite sides of the second wire clamping part 12. Each first sliding part 122 is clamped in the corresponding first chute 421 and are slidingly connected with the first chute 421. The cooperation between the first sliding part 122 and the first chute 421 can ensure that the second wire clamping part 12 always moves in the preset direction to limit and fix the wire at the preset position, in order to ensure the stability of the wire clamping. In this embodiment, the first chute 421 extends in the vertical direction, and the first sliding part 122 is a sliding block protruding from the second wire clamping part 12.

Further, referring to FIGS. 3 and 4, the wire entry component 1 also includes a connected locking block 13 and an adjusting rod 14. The first support plate 42 is provided with a guiding hole 423 extending along the wire clamping direction. The adjusting rod 14 passes through the guiding hole 423 and is movable along the wire clamping direction. The adjusting rod 14 is threadedly connected to the second wire clamping part 12. The second wire clamping part 12 can be locked and limited to the first support plate 42 by twisting the adjusting rod 14 using the locking block 13. When adjusting the position of the second wire clamping part 12, the locking block 13 can be grasped to apply force to drive the adjustment rod 14 to move in the guiding hole 423, thereby driving the second wire clamping part 12 to slide relative to the first support plate 42 and the second support plate 43. Thus, the vertical position of the second wire clamping part 12 can be adjusted and the size of the wire entry space 5 can be adjusted. After the wire penetrates into the wire entry space 5, move the second wire clamping part 12 downward so that the second wire clamping part 12 cooperates with the first wire clamping part 11 to clamp the wire, and then twist the locking block 13 so that the adjusting rod 14 is screwed into the second wire clamping part 12 until the locking block 13 and the second thread clamping part 12 clamp the first support plate 42. At this time, the position of the second wire clamping part 12 is fixed. When it is necessary to adjust the position of the second wire clamping part 12 again, twist the locking block 13 in the reverse direction in advance to release the limit between the locking block 13 and the first support plate 42.

With the arrangement of the locking block 13 and the adjusting rod 14, it is convenient to adjust the position of the second wire clamping part 12. And with the adjusting rod 14 is threadedly connected to the second wire clamping part 12, it is convenient to fix the position of the second wire clamping part 12.

Optionally, referring to FIG. 1 and FIG. 2, the wire feeding component 2 includes a driving member (not shown in the drawings), a driving shaft 21 and a wire feeding wheel 22. The wire feeding wheel 22 is coaxially arranged on the driving shaft 21. One end of the driving shaft 21 is rotatably connected to the first support plate 42 and the other end is rotatably connected to the second support plate 43. The output end of the driving member is connected to the driving shaft 21 for driving the wire feeding wheel 22 to rotate to transport the wire in a preset direction. With such arrangement, automatic wire conveying can be realized by simply controlling the start and stop of the driving member. It is convenient to control and can improve the efficiency of wire stripping. In this embodiment, the middle part of the wire feeding wheel 22 is recessed to form a wire accommodating groove. Wire can be located in the wire accommodating groove, and a plurality of toggle protrusions are provided on the wire feeding wheel 22 at the wire accommodating groove. When the wire feeding wheel 22 rotates, the toggle protrusions drive the wire to move in the preset direction. Illustratively, the driving member is a rotary motor.

Further, the wire feeding component 2 also includes a first bearing 23 and a second bearing 24. The driving shaft 21 and the first supporting plate 42 are rotationally connected through the first bearing 23. The driving shaft 21 and the second supporting plate 43 are rotationally connected through the second bearing 24. Specifically, referring to FIGS. 3 and 4, the first support plate 42 and the second support plate 43 are both provided with installation grooves 424. The first bearing 23 and the second bearing 24 are both fixed in the corresponding installation grooves 424. The two ends of the drive shaft 21 are respectively penetrated and fixed on the first bearing 23 and the second bearing 24.

Further, the wire stripping machine also includes a wire blocking column 6 arranged on the machine base. The wire blocking column 6 is located on the side of the wire feeding wheel 22 that facing away from the wire entry component 1. The wire transported from the wire feeding wheel 22 passes through the top surface of the wire blocking column 6, and the wire blocking column 6 can support the stripped wire so that the stripped wire extends in the preset direction, thereby preventing the wire from being wound around the wire feeding wheel 22 again. Furthermore, a cut-out is provided on the side of the wire blocking column 6 close to the wire feeding wheel 22. The existence of the cut-out can prevent the wire blocking column 6 from interfering with the rotation of the wire feeding wheel 22.

Optionally, referring to FIGS. 1 and 2, the wire stripping component 3 also includes a tool holder 32 connected with a lifting rod 33. The rack 4 also includes a top plate 44 provided at the top of the first support plate 42 and the second support plate 43. The lifting rod 33 passes through the top plate 44 and can be raised or lowered. The wire stripping knife 31 is installed on the tool holder 32. The height of the wire stripping knife 31 can be adjusted by driving the lifting rod 33 up and down, so that the wire stripping knife 31 can cut into the outer sheath of the wire or the wire stripping knife 31 can be moved away from the wire. Moreover, by adjusting the lifting rod 33, the wire stripping knife 31 can cut into the wires with different diameters, so as to strip the wires of different diameters.

In this embodiment, the lifting rod 33 is threadedly connected to the top plate 44 and is rotationally connected to the tool holder 32. That is, by driving the lifting rod 33 to rotate, the lifting rod 33 can be raised or lowered relative to the top plate 44, thereby adjusting the height of the wire stripping knife 31. With the arrangement of the tool holder 32 rotatably connected to the lifting rod 33, it can prevent the tool holder 32 from rotating when the lifting rod 33 rotates, so that the wire stripping knife 31 can maintain the current cutting position. Further, the end of the lifting rod 33 extending out of the top plate 44 is provided with a screwing portion 331. Through the screwing portion 331, the lifting rod 33 can be driven to rotate relative to the top plate 44, so that the lifting rod 33 drives the tool holder 32 and the wire stripping knife 31 to raise or to lower. This improves the convenience of operation.

Furthermore, the wire stripping component 3 further includes an elastic member 34 that is sleeved on the lifting rod 33. The elastic member 34 is compressed and limited between the tool holder 32 and the top plate 44. Since the elastic member 34 is always in a compressed state, it can generate a thrust force on the tool holder 32 to prevent the threaded connection between the lifting rod 33 and the top plate 44 from loosening. Illustratively, the elastic member 34 is a compression spring.

Optionally, referring to FIGS. 3 and 4, the first support plate 42 and the second support plate 43 are both provided with a second chute 422, and second sliding portions 321 are protruding from opposite sides of the tool holder 32. Each second sliding part 321 is snaped in the corresponding second chute 422 and can slide along the second chute 422. The cooperation between the second sliding part 321 and the second chute 422 can ensure that the tool holder 32 always moves in the vertical direction, so that the wire stripping knife 31 directly cuts into the outer sheath of the wire to ensure the quality of stripping. In this embodiment, the second chute 422 extends in the vertical direction, and the second sliding part 321 is a slide block protruding from the tool holder 32.

Further, the base 41 and the first support plate 42, the base 41 and the second support plate 43 are connected and fixed by fasteners such as screws. Also, the top plate 44 and the first support plate 42, the top plate 44 and the second support plate 43 are connected and fixed by fasteners such as screws.

Note that the above are only preferred embodiments and applied technical principles of the present disclosure. Those skilled in the art will understand that the present disclosure is not limited to the specific embodiments herein, and that various obvious changes, readjustments and substitutions can be made by those skilled in the art without departing from the scope of the disclosure. Therefore, although the present disclosure has been described in detail through the above embodiments, the present disclosure is not limited to the above embodiments, and may also include more other equivalent embodiments without departing from the concept of the present disclosure, and the scope of the present disclosure is determined by the scope of the appended claims.

What is claimed is:

1. A wire stripping machine, wherein the wire stripping machine includes:
a wire entry component (1) includes a first wire clamping part (11) and a second wire clamping part (12), the space between the first wire clamping part (11) and the second wire clamping part (12) is adjustable, so that an adjustable-size wire entry space (5) is formed between the first wire clamping part (11) and the second wire clamping part (12), and the wire to be stripped can be inserted through the wire entry space (5);
a wire feeding component (2), the wire feeding component (2) can transport wires inserted through the wire entry space (5) in a preset direction;
a wire stripping component (3) includes a wire stripping knife (31), the wire stripping knife (31) is disposed above the wire feeding component (2) in a liftable manner, the wire stripping knife (31) can cut into the outer sheath of the wire transported on the wire feeding component (2).

2. The wire stripping machine according to claim 1, wherein a first wire clamping groove (111) is provided on the first wire clamping part (11), and a second wire clamping groove (121) is provided on the second wire clamping part (12), the wire entry space (5) is formed by the first wire clamping groove (111) and the second wire clamping groove (121).

3. The wire stripping machine according to claim 1, wherein the wire stripping machine further includes a rack (4), and the second wire clamping part (12) is disposed in the rack (4) with an adjustable installation position along the wire clamping direction, the size of the wire entry space (5) can be adjusted by adjusting the installation position of the second wire clamping part (12).

4. The wire stripping machine according to claim 3, wherein the rack (4) includes a base (41), a first support plate (42) and a second support plate (43), the first support plate (42) and the second support plate (43) are both placed on the base (41), the first wire clamping part (11) is provided on the base (41) and is located between the first support plate (42) and the second support plate (43), two opposite sides of the second clamping part (12) are slidingly connected to the first support plate (42) and the second support plate (43) respectively.

5. The wire stripping machine according to claim 4, wherein a first chute (421) is provided on both the first support plate (42) and the second support plate (43), two first sliding parts (122) are protruding from opposite sides of the second wire clamping part (12), and each first sliding part (122) is clamped in the corresponding first chute (421) and are slidingly connected with the first chute (421).

6. The wire stripping machine according to claim 4, wherein the wire entry component (1) also includes a connected locking block (13) and an adjusting rod (14), and the first support plate (42) is provided with a guide hole (423) extending along the wire clamping direction, the adjusting rod (14) passes through the guiding hole (423) and is movable along the wire clamping direction, the adjusting rod (14) is threadedly connected to the second wire clamping part 12, the second wire clamping part (12) can be locked and limited to the first support plate (42) by twisting the adjusting rod (14) using the locking block (13).

7. The wire stripping machine according to claim 4, wherein the wire feeding component (2) includes a driving member, a driving shaft (21) and a wire feeding wheel (22), the wire feeding wheel (22) is coaxially arranged on the driving shaft (21), one end of the driving shaft (21) is rotationally connected to the first support plate (42), and the other end is rotationally connected to the second support plate (43), the output end of the driving member is connected to the driving shaft (21) and is used to drive the wire feeding wheel (22) to rotate to transport the wire in a preset direction.

8. The wire stripping machine according to claim 4, wherein the wire stripping component (3) further includes a tool holder (32) connected with a lifting rod (33), and the rack (4) further includes a top plate (44) provided at the top of the first support plate (42) and the second support plate (43), and the lifting rod (33) passes through the top plate (44) and can be raised or lowered, the wire stripping knife (31) is installed on the knife holder (32).

9. The wire stripping machine according to claim 8, wherein the lifting rod (33) is threadedly connected to the top plate (44) and is rotationally connected to the tool holder (32), the wire stripping component (3) further includes an elastic member (34) sleeved on the lifting rod (33), the elastic member (34) is compressed and limited between the tool holder (32) and the top plate (44).

10. The wire stripping machine according to claim 8, wherein the first support plate (42) and the second support plate (43) are each provided with a second chute (422), second sliding parts (321) are protruding from opposite sides of the tool holder (32), the second sliding parts (321) are snaped in the corresponding second slide grooves (422) and can slide along the second chute (422).
